(19) United States
(12) Patent Application Publication
(10) Pub. No.: US 2025/0113122 A1
(43) Pub. Date: Apr. 3, 2025

(54) TELEMATICS SYSTEM

(71) Applicant: GM Global Technology Operations LLC, Detroit, MI (US)

(72) Inventors: Christopher L. Oesterling, Troy, MI (US); Prerak Modh, Hanover Park, IL (US); Kelly Amanda Jones, St. Joseph, MI (US)

(73) Assignee: GM Global Technology Operations LLC, Detroit, MI (US)

(21) Appl. No.: 18/478,810

(22) Filed: Sep. 29, 2023

(51) Int. Cl. H04Q 9/00

(52) U.S. Cl. CPC H04Q 9/00

(57) ABSTRACT

A telematics system for a vehicle includes a vehicle processor for storing data including vehicle location, vehicle data, and environmental data. The telematics system also includes a server communicatively coupled to the vehicle processor and configured to determine a range remaining for the vehicle. In some examples, the range remaining is based on vehicle data and environmental conditions.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a telematics system.

Telematics systems are present in many modern day automobiles. Telematics systems combine navigation, safety, security, and communication into one convenient piece of technology that fits in a vehicle's dashboard. In the case of electric vehicles (EV), the telematics system determines and displays a range remaining on a vehicle battery.

As EV's opportunities expand from traditional ground-based automotive vehicles to alternative electric-enabled vehicles such as watercraft, the standard ground-based telematics system technology becomes less accurate because there are additional components and external environmental forces on the vehicle.

### SUMMARY

In some examples, a telematics system for a vehicle includes, a vehicle processor for storing data including vehicle location, vehicle data, and environmental data. The telematics system also includes a server communicatively coupled to the vehicle processor and configured to determine a range remaining for the vehicle. In some examples, the range remaining is based on the vehicle data and the environmental data. Additionally, in some examples, vehicle data includes propulsion data for the vehicle. Additionally, in some examples, the environmental data includes one or more of water current speed, water current direction, and water temperature. In some examples, the range remaining is also based on crowd-sourced vehicle data from nearby vehicles. In some examples, a vehicle incorporates the telematics system. Additionally, in some examples, the vehicle is an electric vehicle. Moreover, in some examples, the vehicle is a watercraft.

In some examples, a telematics system for a vehicle includes a vehicle processor for storing data including vehicle location. The telematics system also includes a server communicatively coupled to the vehicle processor and configured to determine a range remaining for the vehicle, wherein the range remaining is based on the vehicle location and crowd-sourced environmental data. In some examples, the vehicle processor is also configured to store vehicle data including vehicle propulsion data. In some examples, the range remaining for the vehicle is also based on the vehicle data including the vehicle propulsion data. Additionally, in some examples, the crowd-sourced environmental data includes one or more of water current speed, water current direction, and water temperature. In some examples, a vehicle incorporates the telematics systems. Additionally, in some examples, the vehicle is an electric vehicle. Moreover, in some examples, the vehicle is a watercraft.

In some examples, a telematics system for a vehicle includes a vehicle processor for storing data including vehicle location and environmental conditions including tide data. The vehicle location includes one or more of data gathered from a Global Positioning System (GPS) navigation system, data gathered from a user device or a third-party application, or route data including a vehicle destination. The telematics system also includes a vehicle server communicatively coupled to the vehicle processor and configured to determine a time remaining for safe travel. In some examples, the time remaining for safe travel is based on vehicle location and tide data. The vehicle location includes one or more of data gathered from a GPS navigation system, data gathered from a user device or a third-party application, or route data including a vehicle destination. In some examples, the vehicle processor is also configured to store vehicle data including vehicle propulsion data. In some examples, the time remaining for safe travel of the vehicle is also based on the vehicle data including the vehicle propulsion data. In some examples, a vehicle incorporates the telematics system. In some examples, the vehicle is an electric vehicle. Additionally, in some examples, the vehicle is a watercraft.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle having a vehicle processor in communication a server according to the present disclosure:

FIG. 2 is an interior view of a vehicle having a telematics system according to the present disclosure:

FIG. 3 is an exemplary server diagram for the telematics system according to the present disclosure: and

FIG. 4 is an exemplary flow diagram for the telematics system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks: and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

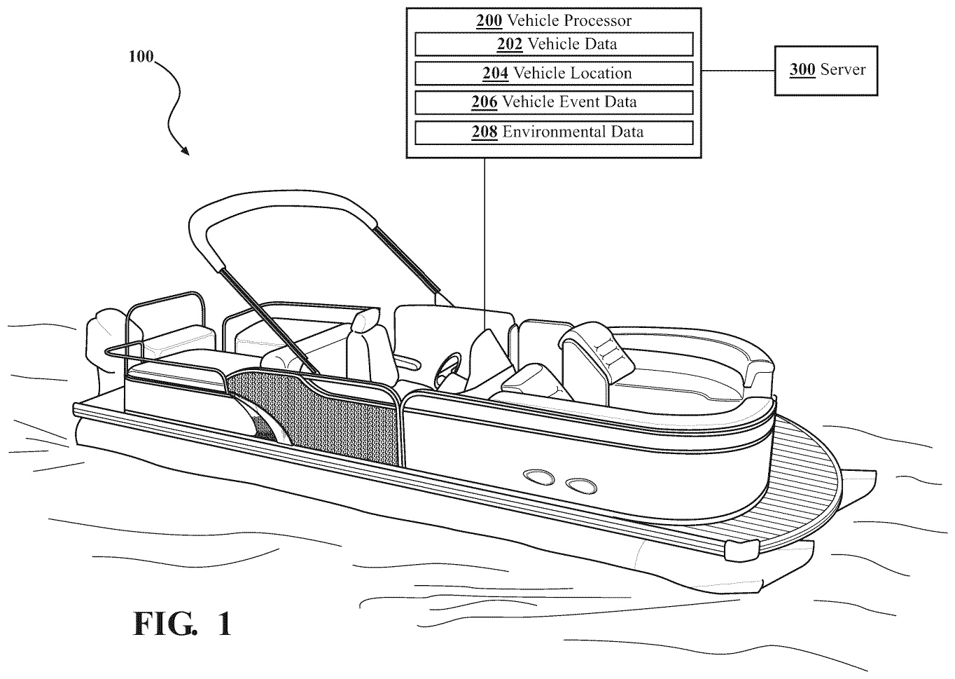

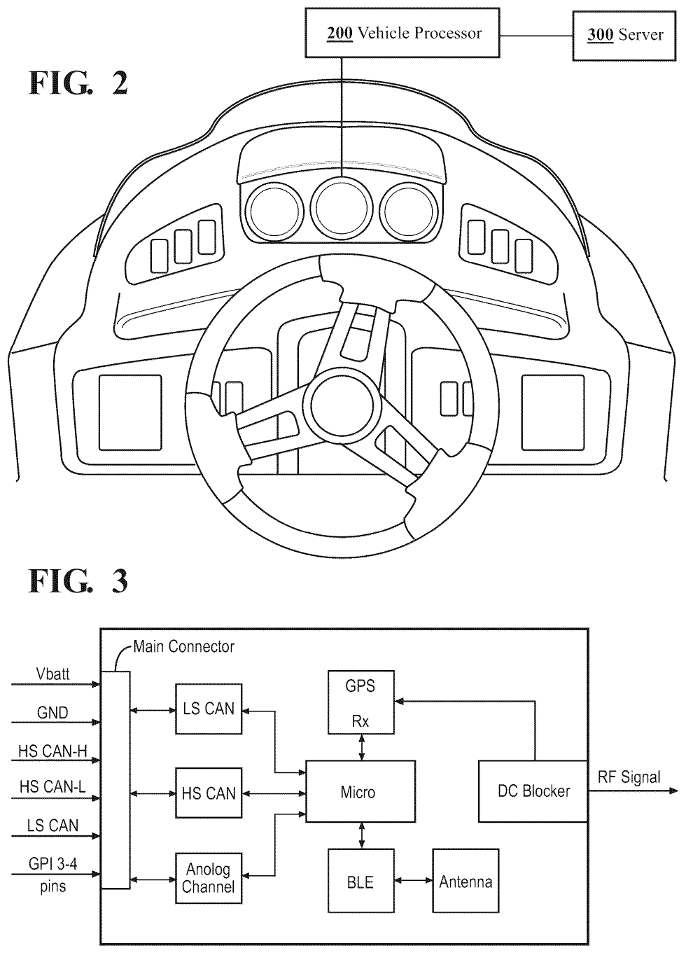

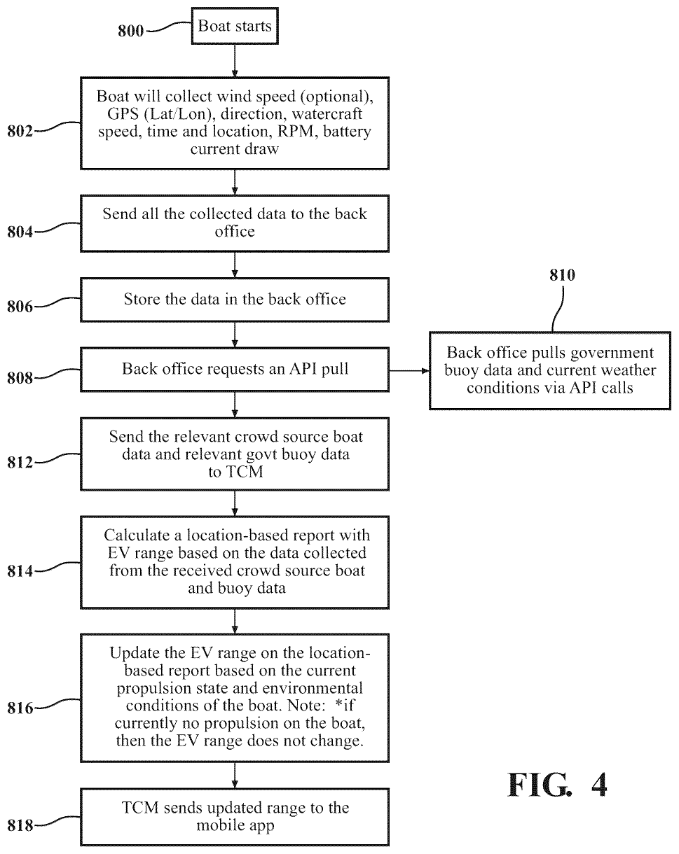

Referring to FIGS. 1-4, a telematics system 100 for a vehicle 10 includes a vehicle processor 200. The telematics system 100 may also include a server 300, described in more detail below, communicatively coupled with the vehicle processor 200. The vehicle 10 is contemplated to be an electric vehicle (EV) and may include autonomous or semi-autonomous capabilities. Additionally or alternatively, the vehicle 10 may be a hybrid vehicle incorporating both EV and internal combustion engine (ICE) components and capabilities. Additionally, the vehicle 10 may include only an internal combustion engine or other power source, if desired. The vehicle processor 200 stores vehicle data 202 of the vehicle 10. In some examples, such as the example shown in FIG. 1, the vehicle may be a watercraft such as a boat or jet ski.

The vehicle data 202 includes vehicle location 204, vehicle event data 206, and environmental data 208. The vehicle location 204 generally pertains to a location of the vehicle 10. The vehicle location 204 may be gathered from a Global Positioning System (GPS), other navigation system, a user device such as a cellular telephone or tablet, or a third-party application and may be communicated to the vehicle processor 200. Moreover, the vehicle location 204 may include route data such that a route the vehicle 10 is traveling may also be communicated to the vehicle processor 200.

The vehicle event data 206 generally pertains to actions the vehicle 10 takes during operation. Vehicle event data 206 may be gathered by any vehicle sensors and/or vehicle cameras used for other applications and communicated to the vehicle processor 200 for further processing. In some examples, vehicle event data 206 may include vehicle speed, vehicle propulsion, vehicle steering wheel angle, vehicle mode, or other vehicle operations. In some examples, the vehicle speed may pertain to the current speed of the vehicle 10, whether the vehicle 10 has stopped, whether the vehicle 10 has quickly changed speed, and other vehicle speed-related events. In some examples, the vehicle propulsion may pertain to the power the vehicle is currently using (i.e. the current battery draw; the power the vehicle has used, and/or the power the vehicle may use along the route based on measurements of sensed data from the vehicle battery or other vehicle sensors). In some examples, vehicle steering wheel angle may pertain to the current or past angle of the steering wheel and whether the angle of the steering wheel has quickly changed indicating a vehicle turn. In some examples, the vehicle mode includes whether the vehicle 10 is in reverse, drive, neutral, park, or the like. Additionally, the vehicle mode may pertain to whether automated driving capabilities such as cruise control or full automation is activated. Other examples of vehicle event data 206 have also been contemplated.

The environmental data 208 generally pertains to any environmental conditions that may affect vehicle travel. In some examples, the environmental conditions are sensed or gathered using vehicle sensors and/or cameras. However, it is also contemplated that the environmental conditions may be gathered from a third-party source including, but not limited to, the National Weather Service, the National Data Buoy Center, or other data services. In some examples, third-party data may be crowd-sourced information obtained from nearby vehicles. Data from nearby vehicles and other third-party sources may be gathered through Bluetooth®, Wi-Fi, third-party applications, or other similar methods.

In some examples, the environmental conditions include water current speed, water current direction, water temperature, tide data, weather data, wind speed and direction, and other environmental measurables. In some examples, water current speed pertains to past, present, and/or future water speeds. The water speed may be measured, sensed, or gathered by the current vehicle, vehicles nearby and/or along the route, and/or from another third-party source. Additionally, in some examples, water current direction pertains to past, present, and/or future water current directions. The water current direction may be measured, sensed, or gathered by the current vehicle, vehicles nearby and/or along the route, and/or from another third-party source. In some examples, water temperature pertains to past, present, and/or future water temperatures. The water temperature may be measured, sensed, or gathered by the current vehicle, vehicles nearby and/or along the route, and/or from another third-party source. In some examples, tide data pertains to past, present, and/or future tide data. The tide data may be measured, sensed, or gathered by the current vehicle, vehicles nearby and/or along the route, and/or from another third-party source. In some examples, weather data pertains to past. present, and/or future weather data. The weather data may be measured, sensed, or gathered by the current vehicle, vehicles nearby and/or along the route, and/or from another third-party source. In some examples, weather data pertains to past, present, and/or future weather data. The weather data may be measured, sensed, or gathered by the current vehicle, vehicles nearby and/or along the route, and/or from another third-party source. In some examples, wind data pertains to past, present, and/or future wind data. The wind data may be measured, sensed, or gathered by the current vehicle, vehicles nearby and/or along the route, and/or from another third-party source. In some examples, the wind data includes wind speed and/or direction. which may be measured or gathered separately from or in conjunction with the weather data.

With further reference to FIGS. 1-4. the server 300 is configured as a network and/or a cloud-based system that communicates with the vehicle processor 200. The server 300 is also configured to communicate with third-party processors 500 to collect third-party data 502. For example. the third-party processors 500 may include, but are not limited to, vehicle processors 200 along the route 324. the National Weather Service, the National Data Buoy Center, or other data services. Additionally or alternatively. the third-party processors 500 may include third-party user devices within vehicles along the route 320. It is generally contemplated that the third-party data 502 may include vehicle location 204. vehicle event data 206. and/or environmental data 208 from the third-party processors. In some examples. the vehicle location 204 is configured to communicate to the server 300 the vehicle location 204 of each respective vehicle traveling along the route. In some examples. the vehicle event data 206 is configured to communicate to the server 300 vehicle events including. but not limited to. vehicle speed. vehicle propulsion data. vehicle steering wheel angle, vehicle mode, or other vehicle operations of each respective vehicle traveling along the route. In some examples. the environmental data 208 is configured to be communicated to the server 300 of the signage information gathered from each respective vehicle traveling along the route and/or from third-party processors such that the National Weather Service or the National Data Buoy Center.

It is also contemplated that the vehicle processor 200 may communicate any or all of the vehicle data 202 to the server 300 for further processing and/or evaluation in some examples. It is also contemplated that the vehicle processor and/or the server 300 may continuously and/or regularly update such that the vehicle data 202 is updated in real time.

Additionally. the server 300 is configured to determine a range remaining for the vehicle 10. In some examples. the range remaining pertains to the amount of operating time the vehicle 10 has prior to the battery life running out. The range remaining may be calculated as a time remaining. a distance remaining. or both. In some examples. the range remaining for the vehicle 10 is determined using vehicle event data and environmental conditions. In some examples. the environmental data may be factored in such that each environmental data weighs equally on the range. However. in other examples. the environmental data may be factored in such the each environmental data is factored differently based on predetermined factors.

For example. the server 300 may be configured to use current propulsion data and water current data to help calculate the range remaining. More specifically. if the current propulsion data is showing a certain value such that calculations of range remaining may be one value but the water current data shows strong water currents are nearby and/or along the route that may affect the actual travel distance of the watercraft, the server 300 will use the water currents in the range remaining calculations to display an accurate range remaining to the user.

Additionally, in some examples, the range remaining for the vehicle 10 is based on vehicle location 204 and crowd-sourced environmental data 208. For example, the server 300 may be configured to use the vehicle's current location and route information along with data from third-party sources such as other vehicles along the same route and/or weather or water condition data from the National Weather Service and/or National Data Buoy Center to determine the range remaining. More specifically, the server 300 may use the vehicle location 204 to determine nearby vehicles and/or vehicles along the route and use their telematics data and/or past, present, and future water conditions to determine the range remaining.

Additionally, in some examples, the server 300 is configured to determine the range remaining for the vehicle 10 based on vehicle location 204 and tide data. For example, the server 300 may determine the current location and route information for the vehicle 10 along with gather the tide data from the National Data Buoy Center or other data sources to determine the range remaining for the vehicle 10. In some examples, the range remaining may also include a warning to the user if it is determined that the tide may impact the range remaining such that the vehicle 10 may get stuck in a low tide.

Referring now to FIG. 4, an example flow diagram of operations of the telematics system 100 is provided. In the example shown, the vehicle 10, such as a boat or watercraft, starts at step 800. When activated, the vehicle 10 will then collect data including, but not limited to, vehicle location 204, wind speed, wind direction, and vehicle event data including vehicle propulsion data at step 802. The collected data is sent to the vehicle processor 300 at step 804 where it is stored at step 806. The vehicle processor 300 also requests and collects data from third-party processors such as the National Data Buoy Center at steps 808 and 810. Next, the data is sent to the server 300 at step 812. The server 300 then calculates a location-based report with range remaining based on the data collected at step 814. Additionally, the range remaining generated from the report generated at step 814 will be updated based on the current propulsion and environment conditions at step 816. The range remaining is then sent to a display on the vehicle 10 or within a third-party application at step 818.

Referring again to FIGS. 1-4, the telematics system 100 includes the vehicle processor 200 storing data including vehicle location 204, vehicle event data 206, and environmental data 208. The vehicle processor 200 may communicate with the server 300 to determine the range remaining for the vehicle 10 based on one or more of vehicle location 204, vehicle event data 206, and vehicle environmental data 208. The server 300 may then notify the user of their remaining range so that the user may plan their route accordingly. Thus, the telematics system 100 may advantageously assist in monitoring the range of an electric vehicle, such as a watercraft and also display that range remaining to allow the user the safely return to shore prior to running out of battery life.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A telematics system for a vehicle, the telematics system comprising:
a vehicle processor for storing data including vehicle location, vehicle data, and environmental data: and a server communicatively coupled to the vehicle processor and configured to determine a range remaining for the vehicle, wherein the range remaining is based on:
the vehicle data and the environmental data.

2. The telematics system of claim 1, wherein vehicle data includes vehicle propulsion data for the vehicle.

3. The telematics system of claim 1, wherein the environmental data includes one or more of water current speed, water current direction, and water temperature.

4. The telematics system of claim 1, wherein the range remaining is also based on crowd-sourced vehicle data from nearby vehicles.

5. A vehicle incorporating the telematics system of claim 1.

6. The vehicle of claim 1, wherein the vehicle is an electric vehicle.

7. The vehicle of claim 1, wherein the vehicle is a watercraft.

8. A telematics system for a vehicle, the telematics system comprising:
a vehicle processor for storing data including vehicle location: and
a server communicatively coupled to the vehicle processor and configured to determine a range remaining for the vehicle, wherein the range remaining is based on:
the vehicle location and crowd-sourced environmental data.

9. The telematics system of claim 8, wherein the vehicle processor is also configured to store vehicle data including vehicle propulsion data.

10. The telematics system of claim 9, wherein the range remaining for the vehicle is also based on the vehicle data including the vehicle propulsion data.

11. The telematics system of claim 8, wherein the crowd-sourced environmental data includes one or more of water current speed, water current direction, and water temperature.

12. A vehicle incorporating the telematics system of claim 8.

13. The vehicle of claim 8, wherein the vehicle is an electric vehicle.

14. The vehicle of claim 8, wherein the vehicle is a watercraft.

15. A telematics system for a vehicle, the telematics system comprising:
a vehicle processor for storing data including vehicle location and environmental data including tide data, wherein vehicle location includes one or more of data gathered from a GPS navigation system, data gathered from a user device or a third-party application, or route data including a vehicle destination; and
a vehicle server communicatively coupled to the vehicle processor and configured to determine a time remaining for safe travel, wherein the time remaining for safe travel is based on:
the vehicle location including one or more of the data gathered from a GPS navigation system, the data gathered from a user device or a third-party application, or the route data including the vehicle destination, and the environmental data including the tide data.

16. The telematics system of claim 15, wherein the vehicle processor is also configured to store vehicle data including vehicle propulsion data.

17. The telematics system of claim 16, wherein the time remaining for safe travel of the vehicle is also based on the vehicle data including the vehicle propulsion data.

18. A vehicle incorporating the telematics system of claim 15.

19. The vehicle of claim 18, wherein the vehicle is an electric vehicle.

20. The vehicle of claim 18, wherein the vehicle is a watercraft.
